(19) United States
(12) Patent Application Publication
(10) Pub. No.: US 2016/0116355 A1
(43) Pub. Date: Apr. 28, 2016

(54) METHOD FOR DETERMINING THE COMPRESSION LEVEL OF A NODE AFTER ULTRASONIC WELDING

(71) Applicant: SCHUNK SONOSYSTEMS GMBH, Wettenberg (DE)

(72) Inventor: Dieter STROH, Wettenberg (DE)

(73) Assignee: Schunk Sonosystems GMBH, Wettenberg (DE)

(21) Appl. No.: 14/888,988

(22) PCT Filed: May 12, 2014
(86) PCT No.: PCT/EP2014/059589

§ 371 Date: Nov. 4, 2015

(30) Foreign Application Priority Data
May 13, 2013 (DE) 10 2013 104 895.1
Jun. 18, 2013 (DE) 10 2013 106 349.7

(51) Int. Cl. G01L 5/00

(52) U.S. Cl. CPC G01L 5/0076

(57) ABSTRACT

A method for determining the compression level of a node by compacting and welding electrical lines inserted into a compression chamber of an ultrasonic welding system, the compression chamber having an adjustable height and width. The method includes inserting the lines into the compression chamber, compacting the lines, determining the compacting cross section of the compacted lines, determining the actual total cross section via a correlation function taking the compacting cross section into account, welding the compacted node with a welding parameter set, determining the welding dimension from the height (h2) and width (b) of the compression chamber after welding, and calculating the compression level based on the actual total cross section and the welding dimensions.

The invention relates to a method for determining the compression level of a node by compacting and welding electrical lines inserted into a compression chamber of an ultrasonic welding system, which compression chamber can be adjusted in height and width. These electrical lines have a known total nominal cross section Aₙₒₘ and consist of wires with an actual total cross section Aₜₐₜₛ.

A method for compacting and subsequently welding electrical lines, in particular for producing through nodes or end nodes of strands by ultrasound in a compression chamber that can be adapted to the conductors is known from EP 701 876 A1.

For the compacting and subsequent welding of electrical lines, in particular for producing through nodes and end nodes of strands, ultrasonic welding devices are used that comprise sonotrodes for the producing of ultrasonic oscillations. A section of the particular sonotrode forms a first lateral limiting surface of a compression chamber that is open on the front and can be adjusted in height and width. The other limiting surfaces of the compression chamber can be sections of a multipartite counterelectrode and of a lateral slider. Examples for ultrasonic welding devices are devices offered under the designations GS-40/50 or Minic II of the Schunk Sonosystems GmbH, Wettenberg, Federal Republic of Germany.

A method and a device are known from DE 43 35 108 C1 for compacting and subsequently welding conductors, in particular for producing through nodes or end nodes of strands by ultrasound in a compression chamber adapted to the conductors and adjustable in height and width, wherein the conductors to be welded are at first compacted and then welded. The compression chamber can be adjusted to a given height-width ratio independently of the cross section of the conductors to be welded.

A method for the welding of connection cables for transformers is known from WO 91/09704 A1. In order to achieve a secure connection by ultrasound, the cable ends to be welded are chamfered.

A method and a device for welding metallic work pieces by ultrasound can be gathered from EP 0 421 018 A1. It is provided in order to ensure the quality of the welding results that the lowering speed of a sonotrode is controlled as a function of measurements and the construction of the work pieces to be welded and their coating.

In order to meet the current requirements, it must be ensured that material changes and/or a changing of the persons operating the ultrasonic device do not have an influence on the welded final products.

According to the prior art, e.g., Cu- or Al lines are characterized according to a standard with a nominal cross section such as, for example 5 mm² However, these lines have an actual cross section of for example 4.3 mm² with the same conductivity, which cross section is less than the nominal cross section.

In the ultrasonic welding of, for example 4 lines with a nominal cross section of 5 mm² a welding node with a total nominal cross section Aₙₒₘ of 4×5 mm²=20 mm² would be produced which, however, does not coincide with the actual total cross section Aₜₐₜₛ.

In order to check the quality of a welding node there is, according to the prior art, among other things the determining of a so-called compression level V. In it the height and the width of the finished welding node are measured and related to an actual cross section previously manually determined from the individual lines according to one of the formulas

V=[Aₜₐₜₛ/b·(h−0.2)]·100 in % a)

or

V=[b·h/Aₜₐₜₛ]·100 in %. b)

Here, Aₜₐₜₛ is the actual cross section of the lines, that is, of their wires, b=width and h=height of the compression chamber after the welding.

The checking of the compression level of the welding takes place outside of the compression chamber and is associated with a great expenditure of time and cost.

Starting from the above, the present invention has the problem of further developing a method of the initially cited type in such a manner that that the averaging of the compression level is simplified.

According to the invention the following is suggested:
Placing the lines into the compression chamber,
Compacting the lines taking as base the total nominal cross section Aₙₒₘ,
Determining the cross section of compaction A of the compacted lines,
Determining the actual total cross section Aₜₐₜₛ with a correlation function that takes into account the compacting cross section A,
Welding the compacted node with a welding parameters set for the total nominal cross section Aₙₒₘ or the actual total cross section Aₜₐₜₛ,
Determining a welding dimension from the height and the width of the compression chamber after the welding,
Calculating the compression level taking as base the actual total cross section Aₜₐₜₛ and the welding dimension.

Note concerning the correlation function that it is a determined correlation for defined line types and tool profile geometries. The line types can be, e.g., FLRY type A or type B, i.e., lines with the same nominal cross section with a different construction of wires, i.e., a different wire number or strand number and wire diameter or strand diameter. For a cross-section of, e.g., 0.5 mm² line type A has 19 wires, each with a diameter of 0.19 mm and line type B has 16 wires each with a diameter of 0.21 mm.

In general, the correlation function is determined in that lines with actual total cross sections that differ from each other and were previously determined are compacted in advance, that the quotient of each actual total cross section and the determined associated compacting cross section is formed and that the correlation function is formed by plotting the quotient opposite the nominal cross sections associated with the actual total cross sections.

The correlation function, which is filed in the ultrasonic welding system or in its computer or control unit, can be determined in advance, for example, in a base machine and then implemented in corresponding ultrasonic welding systems. However, there is the possibility that a “learning” about the compacting of lines with different total nominal cross sections and associated actual total cross sections and a determining of associated actual compacting cross sections takes place with each machine used. Based on the measuring results, the correlation function is then determined and filed in the ultrasonic welding system.

The invention is distinguished over the prior art in that the actual total cross section Aₜₐₜₛ and the compression level are calculated online, wherein solely and only the nominal cross section of the lines to be welded to a node and, if necessary, the tool geometry and/or its profiling must be known in as far as the latter are used in the calculation of the compression level.

In order to calculate the compression level V, currently known formulas with or without profile correction PK are used that are given, for example, in the automobile industry.

Profile correction PK means here that the geometry of sonotrode and counterelectrode, that is, the anvil, to the extent that they delimit the compression chamber, are included in the calculation.

The following can be used as formulas for calculating the compression level V:

V=[Aₜₐₜₛ/b·(h−PK)]·100 in % a)

or

V=[b·h/Aₜₐₜₛ]·100 in %, b)

with h=height and b=width of the compression chamber after the welding of the node.

The results from a), b) are not directly comparable, i.e., different target values apply. The formula preferred in the invention is the formula a).

The profile correction PK is preferably in the range of 0.1≦PK≦0.5, preferably PK=0.2.

Other details, advantages and features of the invention result not only from the claims, the features to be gathered from them individually and/or in combination but also from the following description of an exemplary embodiment to be gathered from the drawings.

In the drawings:

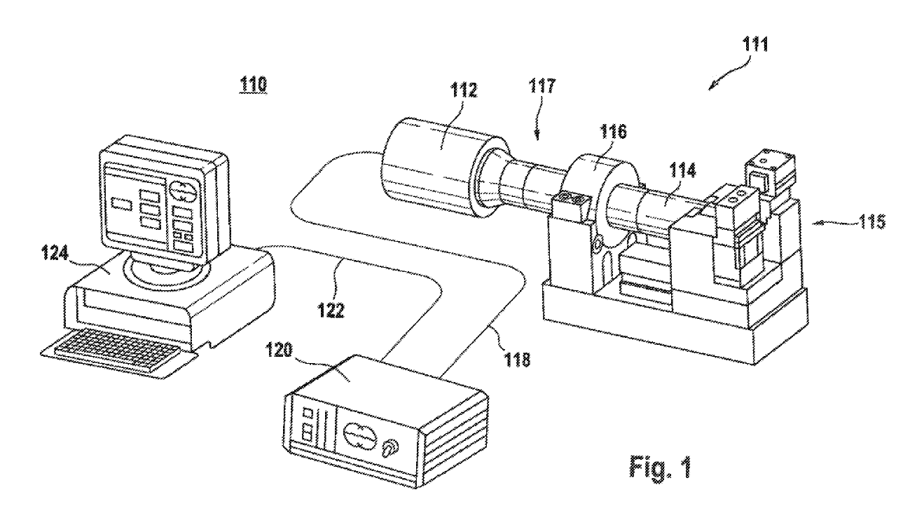

FIG. 1 shows a basic view of an ultrasonic welding system,

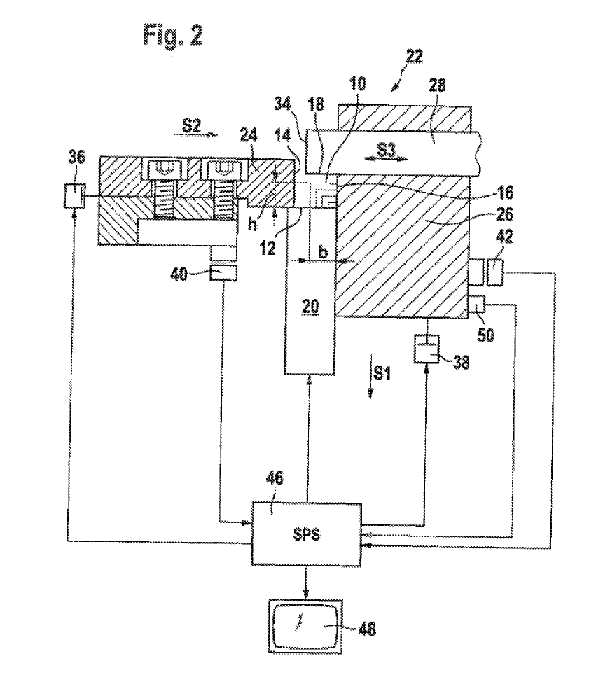

FIG. 2 a section of an ultrasonic welding device with a variable compression chamber,

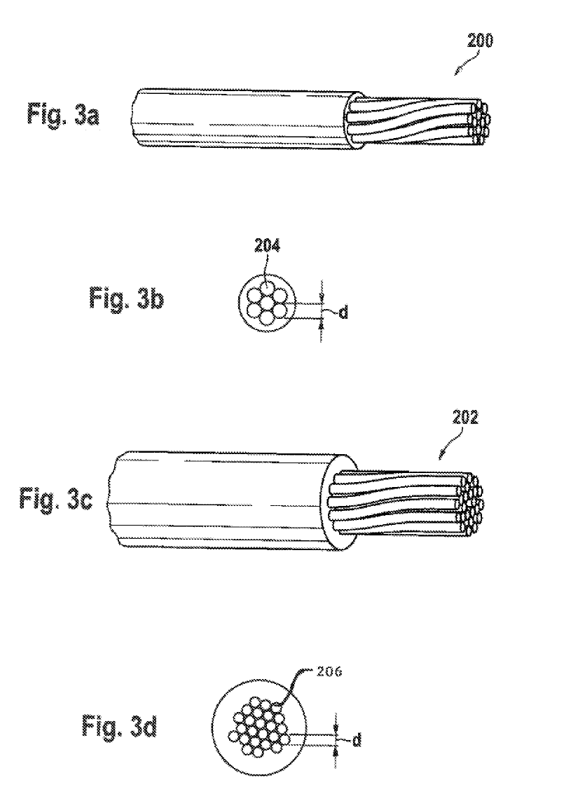

FIG. 3a)-d) Lines with different constructions,

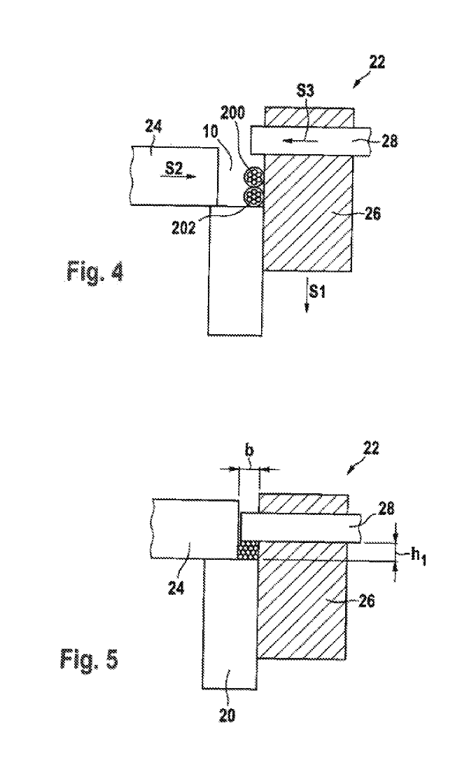

FIGS. 4 and 5 Method steps for compacting lines,

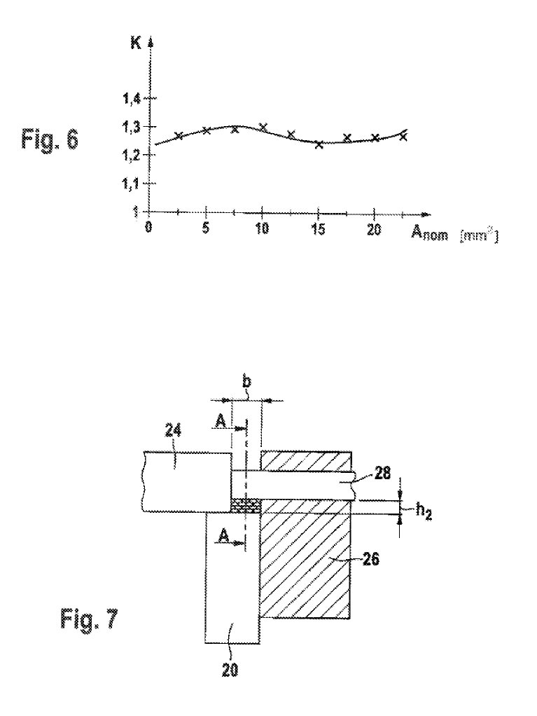

FIG. 6 A correlation function,

FIG. 7 Basic views of the method step of the welding, and

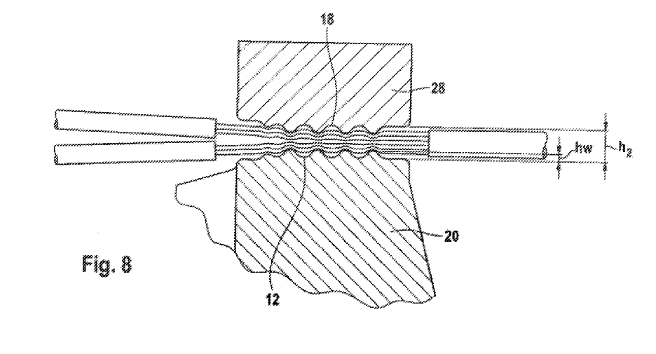

FIG. 8 A section along the line A-A in FIG. 7.

FIG. 1 shows a basic view of an ultrasonic welding system 110 with which the essential elements are explained for welding electrical lines to a final node or through node.

The ultrasonic welding system 110 comprises as essential elements a converter 112 and a sonotrode 114 between which a booster 116 for amplitude amplification is arranged. Converter 112, booster 116 and sonotrode 114 form a so-called ultrasonic oscillator 117 that is supported in booster 116. The sonotrode 114, i.e., its head, which cannot be recognized in FIG. 1, is associated with a counterelectrode 115. The counterelectrode 115 can be lowered in order to introduce forces during welding onto the joining partners, that is, lines. Furthermore, lateral sliders are present in order to be able to adjust a compression chamber surrounded by sonotrode 114, counterelectrode or anvil 115 and lateral sliders to the desired extent in height and width.

The converter 112 is connected via a line 118 to a generator 120 that is connected for its part via a line 122 to a computer 124. The converter 112, i.e., the piezoceramic disks arranged in it, is loaded via the generator 120 with high-frequency voltage in order to expand or contract the disks in a corresponding manner as a result of which ultrasonic oscillations are produced with an amplitude that are transmitted amplified by the booster 116 onto the sonotrode 114.

FIG. 2 shows a section of an ultrasonic welding device for welding electrical lines which comprises a compression chamber 10 that can be adjusted for the lines to be welded. The ultrasonic welding device itself can basically correspond to a construction corresponding to the device GS-40/50 or Minic II of the Schunk Sonosystems GmbH, Wettenberg.

The compression chamber 10 has a rectangular cross section in the exemplary embodiment and is open on the front in order to run the lines to be welded through it. Compression chambers with other cross sections are of course also possible, such as, in particular those with a trapezoidal cross section.

The compression chamber 10 is surrounded on its sides by delimiting surfaces 12, 14, 16 and 18, which are sections of a sonotrode 20, a multipartite counterelectrode 22 such as an anvil and of a lateral slider 24.

The slider 24 can be shifted along the sonotrode 20 and forms the lateral delimiting surface 12. The direction of the movement of the slider 24 is indicated by the arrow S2. The counterelectrode 22 is constructed in a known manner in a bipartite form and comprises a carrier 26—also called a surface plate—from which a crossbar 28 that can shift in the direction of the arrow 53 emanates via which the required forces can be transmitted onto the lines placed in the compression chamber 10 during the compacting and welding. The crossbar 28 forms the delimitation surface 18 and the carrier 26 forms the delimitation surface 16 of the compression chamber 10. The surface 18 of the crossbar 28 runs parallel to the delimitation surface 12 formed by the sonotrode 20.

The compression chamber 10 surrounded by the delimitation surfaces 12, 14, 16 and 18 is changed as a function of the lines to be welded.

The compression chamber 10 is set to a previously determined width b for compacting the inserted lines, that is, for the pre-compression. The width b of the compression chamber 10 is a function here of the nominal cross section of the lines to be compressed to a node and welded.

The slider 24 is connected to a drive 36, in particular to a pneumatic or hydraulic drive by which the slider 24 can be moved in the direction of the arrow S2 and inversely. The carrier 26 of the counterelectrode 22 is connected to a drive 38 that can also be constructed preferably as a pneumatic or hydraulic drive.

The carrier 26 can be shifted by the drive 38 in the direction of the arrow S1 and inversely. Furthermore, the slider 24 is connected to a position transmitter 40 with which the position of the slider 24 relative to a rest position can be measured. Even the carrier 26 is connected to a position transmitter 42 with which the position of the carrier 26 relative to a rest position can be determined.

A control device 46, e.g. a control that can be programmed in a memory, is connected to the position transmitters 40, 42 of the sonotrode 20 emitting ultrasound and to the control elements (not shown in more detail) for the drives 36, 38. A monitor 48 is connected to the control device 46.

The height h and/or the width b of the compression chamber 10 is determined by at least one position transmitter and by measured values generated by the position transmitters 40, 42 and evaluated by the control device 46. Different cross sections and different heights or widths of the compression chamber 10 are associated with different parameters that are adjusted by the ultrasonic welding device for compacting and welding the lines. This concerns compacting parameters and welding parameters such as energy, amplitude, pressure time and welding time.

During the welding in particular the height h of the compression chamber 10 is changed, wherein the width b stays the same since, e.g. after the conclusion of a pre-compression performed on the lines the slider 24 is stopped.

A force sensor 50 can also be connected to the carrier 26 with which the force is measured that is exerted on the lines by the carrier 26, which lines are placed in the compression chamber 10. The force sensor 50 is also connected to the control unit 46. Of course, an indirect measuring by pressure regulation can also take place.

The lines placed into the compression chamber 10 are at first compacted with the above-described device in that the slider 24 is adjusted in such a manner that the width of the compression chamber 10 is reduced to a dimension that is a function of the total nominal cross section of the lines and is filed as parameter in the computer of the ultrasonic welding system. Then the height h is changed during the compacting. Forces for the adjusting of the cross section are initiated by the control unit 46 via signals emanating to the drives 36, 38, wherein the particular cross section of the compression chamber 10 being adjusted is determined by the measured values of the control unit 46 produced by the position transmitters 40, 42.

The cross section or the height h or the width b of the compression chamber 10 at the end of or after the ending of the pre-compression, that is, of the compacting, is accordingly a measure for the level of the pre-compression, i.e., the geometry of the compression chamber 10 can be used and/or evaluated as a measure of the compacting. Since, e.g. only the width b and/or the height h of the compression chamber 10 is changed, the cross section can be rapidly and simply determined automatically.

If a force sensor 50 is present even the force exerted on the lines can be used as a compacting measure.

The width b of the compression chamber 10 to be adjusted during compacting is a function of the total nominal cross section of the lines to be compacted. In customary compacting and welding procedures the width b is between 0.5 mm and 15 mm. The pressure acting during the compacting on the line is usually between 1 bar and 6 bar. During the compacting an ultrasonic impulse can be introduced onto the lines. The impulse time is between 50 ms and 200 ms. The amplitude should be between 15 μm and 20 μm at a frequency of 20 kHz.

During the welding procedure the cross section—basically only the height h and the width b—of the compression chamber 10 is changed again, wherein the cross section present at or after the end of the welding is a measure for the quality of the welding of the lines.

Since the compacting level and the welding level can be adjusted by positioning components such as the slider 24 and/or the counterelectrode 22, corresponding theoretical values are inputted into the control unit 46. Furthermore, fixed upper and lower boundary values for the compacting levels and welding levels are inputted into the control unit 46. These boundary values are designated as outer boundary values. Other boundary values that are designated in the following as inner boundary values and that set an upper and a lower boundary for the compacting level and/or for the welding level during the manufacture of welded lines are determined by the control unit 46.

The following method is carried out with the above-described device.

In a first step the ultrasonic welding device is started. Then, in a first step a desired combination of known lines is placed into the compression chamber 10 which is set for the known total nominal cross section of the lines by the computer of the ultrasonic welding system. The compacting process is subsequently started. Thus, the compression chamber 10 is closed in that the slider 24 and the multipartite counterelectrode 22 are driven or moved in the direction of the arrows S2, S3 and S1.

The width b of the compression chamber 10 is usually not changed so that the slider 24 is not moved. Consequently, during the compacting only the height of the compression chamber 10 is changed.

During the closing of the compression chamber 10 or subsequently an ultrasonic impulse or a sequence of them is generated in order to compact the lines more strongly. This really results in a homogenization of the compacting. After the compacting the compacting level, in particular the compacting height h is determined in a subsequent step from the geometry of the compression chamber 10, that is determined by the knowledge of the width b and/or the height h or of another specific magnitude.

After the measuring of the compacting height h the calculation of the actual total line cross section A_{TATS} takes place in a next step by a correlation function. According to a first alternative this is a determined correlation for defined line types and tool profile geometry. Line types are, e.g. FRLY type A or type B, i.e. lines with the same nominal cross section with a different wire construction, i.e. a different strand number and strand diameter for a cross section. E.g., a 0.5 mm² line type A has nineteen wires with a diameter of 0.19 mm and a line type B has sixteen wires with a diameter of 0.21 mm.

Alternatively, a “learning” about the insertion and compression of known/determined actual cross section and the calculating of the correlation function takes place.

After the calculation of the actual total cross section Aₜₐₜₛ with the correlation function a query takes place, namely, whether a welding should take place with a parameter set for the nominal cross section or with a parameter set for the actual total cross section.

After the selection of the appropriate parameter set the ultrasonic welding is carried out.

During the welding the width b of the compression chamber remains basically unchanged in comparison to the compacting and is likewise 0.5 mm to 15 mm During the welding a pressure between 1 bar and 6 bar is exerted on the lines. The energy that is supplied to the oscillator 117 is between 50 Ws and 10,000 Ws. The total welding time is between 0.2 sec and 2 sec at an oscillation amplitude between 15 μm and 30 μm. These values are purely exemplary without the invention being limited by them.

Finally, the determination of the welding level takes place in that the width b and the height h or some other specific magnitude of the compression chamber 10 is detected.

According to the invention the calculation of the compression level V takes place online, i.e. directly after the conclusion of the welding, wherein the compression level is determined from the determined actual total cross section Aₜₐₜₛ and the determined welding level, i.e. the height h and width b of the welding node. The calculation of the compression level V can take place based on known formulas:

V=[Aₜₐₜₛ/b·(h−PK)]·100 in % a)

or

V=[b·h/Aₜₐₜₛ]·100 in %, b)

wherein the results from a) and b) are not directly comparable, i.e. different target values apply. According to the invention formula a) is preferred.

In the formula PK is a magnitude that take into account the geometry or profiling of the delimiting surfaces 12 and 18 of the compression chamber 10, therefore that of the sonotrode 20 and of the crossbar 28 of the counterelectrode 22, which crossbar transmits the force. The factor PK is normally in a range between 0.1 and 0.5. The value of approximately 0.2 is preferably used for the start. b signifies the width and h the height of the compression chamber 10 after the conclusion of the welding process and consequently represents the cross section of the node produced.

Preferred tool geometries are: wave geometries with adapted wave height, wave interval, wave shapes and wave number; cross corrugation with pyramids or pyramid butt ends.

In a preferred embodiment the compression level V is displayed graphically and numerically after each welding and can be stored or recorded.

The essential features of the invention are illustrated once again using FIGS. 3 to 8.

FIGS. 3a) to 3d) are sections or cross sections of lines 200, 202 shown in a purely basic manner. The line 200 has a symmetrical construction and has, e.g., a nominal cross section of 0.50 mm² The number of wires 204 is 7. The diameter of each wire 204 is 0.29 mm Therefore, an actual total cross section of 0.46 mm² results according to the calculations that recognizably deviates from the nominal cross section.

The line 202 according to FIG. 3c) has an asymmetrical construction with a total of 24 wires 206. The diameter of each wire is, e.g., 0.19 mm so that an actual total cross section of 0.68 mm² results. However, the nominal cross section is indicated with 0.75 mm².

The ultrasonic welding system 110 is customarily preprogrammed in such a manner that compacting parameters and welding parameters for previously known lines are stored in it. The operator knows the nominal cross section of the lines to be welded to a node. The nominal cross section here is the one that results from all lines. In order to weld a node from several lines, consequently the entire nominal cross section is inputted at first into the control. On their basis compacting parameters filed in the control are retrieved. The lines are placed into the compression chamber 10, the width b of the compression chamber adjusted and then the compacting is carried out by lowering the anvil 22 without the width b being changed. This is illustrated using FIGS. 4 and 5. Therefore, at first the lines 200, 202 are placed into the compression chamber 10 in order to then adjust the slider 24 to a given value in order to then move the crossbar 28 of the multipartite counterelectrode 22 in the direction of the slider 24 and to lower the anvil 22 in the direction of arrow S1. Pressure, amplitude and energy are automatically adjusted according to the previously known total nominal cross section as compacting parameters. After the compacting the lines 200, 202 have a compacting cross section A1 that is determined by the width b of the compression chamber 10 and the height h1.

Then, lines with different total nominal cross sections are compacted in one and the same ultrasonic welding device according to previously described methods in order to determine appropriate compacting cross sections A₁ . . . Aₙ as a function of the different total nominal cross sections.

Then, a correction value K is determined for each total nominal cross section that results from the quotient from the compacting cross sections A₁ . . . Aₙ of the compacted lines and from the actual total cross section Aₜₐₜₛ . . . Aₜₐₜₛₙ of the lines to be welded. The particular actual total cross section Aₜₐₜₛ is the one resulting from the number and diameters of the wires of the lines that are to be welded. A correlation function is subsequently determined in which the dimensionless correction values K are plotted opposite the total nominal cross sections Aₙₒₙ in mm² as is shown by way of example in FIG. 6. In this manner, given the known total nominal cross section and the determined compacting cross section, the actual total cross section Aₜₐₜₛ can be directly calculated since the corresponding correlation function was filed in the computer of the ultrasonic welding system. The correlation function consequently results from the individual correction values K as a function of the total nominal cross sections Aₙₒₘ.

The actual total cross section Aₜₐₜₛ consequently results from the formula

Aₜₐₜₛ=A:K,

in which K is the correction value determined from the correlation function as a function of the total nominal cross section and A is the compacting cross section for the line with the total nominal cross section.

In order to now determine the compression level of a node when using a corresponding ultrasonic welding device the compacting parameters are automatically adjusted in the previously described manner at first as a function of the known total nominal cross section in order, after the placing of the lines in the compression chamber 10, to compact them. At the end of the compacting the compacting cross section A is automatically determined from the dimensions of the compression chamber 10 in order to therefore calculate the actual total cross section Aₜₐₜₛ taking into account the correlation function. After the compacting the welding is carried out. The welding parameters are retrieved either as a function of the total nominal cross section or of the actual total cross section. After the welding the welding level representing the cross section of the node is automatically determined from the geometry of the compression chamber in order to then calculate online the compression level V, taking into account the actual total cross section Aₜₐₜₛ, which can then be displayed graphically and/or numerically on a monitor of the ultrasonic welding device. A storing of the values also takes place.

During the determination of the compression level the profiling of the delimiting surface formed by the sonotrode 20 and the counterelectrode 22 and of the crossbar 28 can also take place as is basically illustrated using FIG. 8. In this manner the magnitude PK enters according to the previously given formula b), which magnitude is given in the exemplary embodiment by the height hw of the profiling of the surface of the sonotrode 10 delimiting the compression chamber 10 or of the anvil 22. The correction factor PK serves to compensate the wave structure. The magnitude hw depends on the tool types used. The profile correction PK is usually between 0.1 and 0.5, preferably in the area of 0.2.

1. A method for determining the compression level V of a node by compacting and welding electrical lines (200, 202) inserted into a compression chamber (10) of an ultrasonic welding system (110), which compression chamber can be adjusted in height (h) and width (b). These electrical lines have a known total nominal cross section Aₙₒₘ and consist of wires (204, 206) with an actual total cross section Aₜₐₜₛ, characterized by the method steps:
Placing the lines (200, 202) into the compression chamber (10),
Compacting the lines,
Determining the cross section of compaction A of the compacted lines,
Determining the actual total cross section Aₜₐₜₛ with a correlation function that takes into account the compacting cross section A,
Welding the compacted node with a set of welding parameters, taking as base the total nominal cross section Aₙₒₘ or the actual total cross section Aₜₐₜₛ,
Determining a welding dimension from the height (h) and the width (b) of the compression chamber (10) after the welding,
Calculating the compression level taking as base the actual total cross section Aₜₐₜₛ and the welding dimension.

2. The method according to claim 1,
wherein lines (200, 202) with actual total cross sections that differ from each other and were previously determined are compacted and that the quotient of each actual total cross section and the associated compacting cross section is formed and that the correlation function is formed by plotting the quotient opposite the total nominal cross section associated with the actual total cross section.

3. The method according to claim 1,
wherein in the calculation of the compression level profile geometries of the sonotrodes surfaces and counterelectrode surfaces (12, 18) of the ultrasonic welding system (110) which delimit the compression chamber are taken into account.

4. The method according to claim 1,
wherein the compacting of the lines (200, 202) is carried out with compacting parameters based on the total nominal cross section.

5. The method according to claim 1,
wherein pressure introduced into the lines (200, 202) and/or ultrasonic amplitude and/or ultrasonic energy are used as welding- and/or compacting parameters.

6. The method according to claim 1,
wherein, the compression level is displayed graphically and/or numerically.
